(19) United States
(12) Patent Application Publication
(10) Pub. No.: US 2011/0176233 A1
(43) Pub. Date: Jul. 21, 2011

(54) MIRROR DEVICE

(75) Inventors: Yuya KISHIMOTO, Wako (JP); Toshihiro Hashimoto, Wako (JP)

(73) Assignee: HONDA MOTOR CO., LTD., Tokyo (JP)

(21) Appl. No.: 12/958,409

(22) Filed: Dec. 2, 2010

(30) Foreign Application Priority Data
Jan. 18, 2010 (JP) 2010-008017

(51) Int. Cl. B60R 1/08

(52) U.S. Cl. 359/869

(57) ABSTRACT

A mirror device includes a reflecting surface. The reflecting surface is arranged in a vicinity of a rear window of a vehicle. The reflecting surface includes a concave part in a longitudinal direction of the reflecting surface and a convex part in a lateral direction of the reflecting surface. A line passing through a center of a virtual circle defining the concave part is inclined relative to a virtual horizontal line extending in a vehicle width direction toward a side opposite to a driver seat on either right or left of the vehicle in the vehicle width direction.

### CROSS-REFERENCE TO RELATED APPLICATIONS

The present application claims priority under 35 U.S.C. §119 to Japanese Patent Application No. 2010-008017, filed Jan. 18, 2010, entitled “Mirror Device”. The contents of this application are incorporated herein by reference in their entirety.

### BACKGROUND OF THE INVENTION

1. Field of the Invention

The present invention relates to a mirror device.

2. Description of the Related Art

An under-view mirror, allowing a driver to indirectly view a place which the driver cannot directly view, has been known as a mirror device. The under-view mirrors often include convex mirrors, each providing a mirror image corresponding to a wide area on a small reflecting surface. Disadvantageously, since the under-view mirror including the convex mirror provides an inverted mirror image, it is difficult for a user to recognize the image. If the under-view mirror is mounted in the interior of a vehicle, the convex mirror provides a narrower visible area near the vehicle than that provided by a concave mirror. In recent years, under-view mirrors each including, as a mirror surface, a toroidal surface that includes convex part in the X direction and includes concave part in the Y direction have been proposed (see, for example, Japanese Unexamined Patent Application Publication No. 61-287842 and Japanese Patent No. 3028088). In the use of the toroidal surface, the convex part provides a mirror image corresponding to a wide area in the X direction and the concave part provides an erect mirror image. As for a visible area near a vehicle, the toroidal surface can reflect an area in the immediate vicinity of the vehicle as a mirror image in a manner similar to the above-described concave mirror.

The above-described related-art mirror devices are designed such that the direction in which the convex part is provided corresponds to the width direction of the vehicle (hereinafter, referred to as the “vehicle width direction”) and the direction in which the concave part is provided corresponds to the height direction of the vehicle. The concave part largely affects the parallax of both eyes. Accordingly, if the right and left eyes of a driver are not at the same level, information items obtained by the eyes differ from each other. Disadvantageously, the driver feels uncomfortable in a mirror image or feels that the mirror image is difficult to see because the driver's brain cannot process the information items. Unfortunately, the driver may fail to immediately recognize an object as a mirror image.

### SUMMARY OF THE INVENTION

According to one aspect of the present invention, a mirror device includes a reflecting surface. The reflecting surface is arranged in a vicinity of a rear window of a vehicle. The reflecting surface includes a concave part in a longitudinal direction of the reflecting surface and a convex part in a lateral direction of the reflecting surface. A line passing through a center of a virtual circle defining the concave part is inclined relative to a virtual horizontal line extending in a vehicle width direction toward a side opposite to a driver seat on either right or left of the vehicle in the vehicle width direction.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of a mirror device according to an embodiment of the present invention;

FIG. 2 illustrates an area that can be viewed through the mirror device according to the embodiment;

FIG. 3 illustrates a toroidal mirror surface;

FIG. 4 illustrates a reflecting surface in the embodiment when viewed from the front part of the interior of a vehicle;

FIG. 5 illustrates the positional relationship between a driver in a right-hand drive vehicle and the reflecting surface in the embodiment;

FIG. 6 illustrates the driver who turns around toward the rear of the vehicle in FIG. 5 when viewed from the rear part of the interior of the vehicle;

FIG. 7 illustrates the reflecting surface in the embodiment when viewed from the front part of the interior of a left-hand drive vehicle;

FIG. 8 illustrates the positional relationship between the driver in the left-hand drive vehicle and the reflecting surface in the embodiment; and

FIG. 9 illustrates the driver who turns around toward the rear of the vehicle in FIG. 8 when viewed from the rear part of the interior of the vehicle.

### DESCRIPTION OF THE EMBODIMENTS

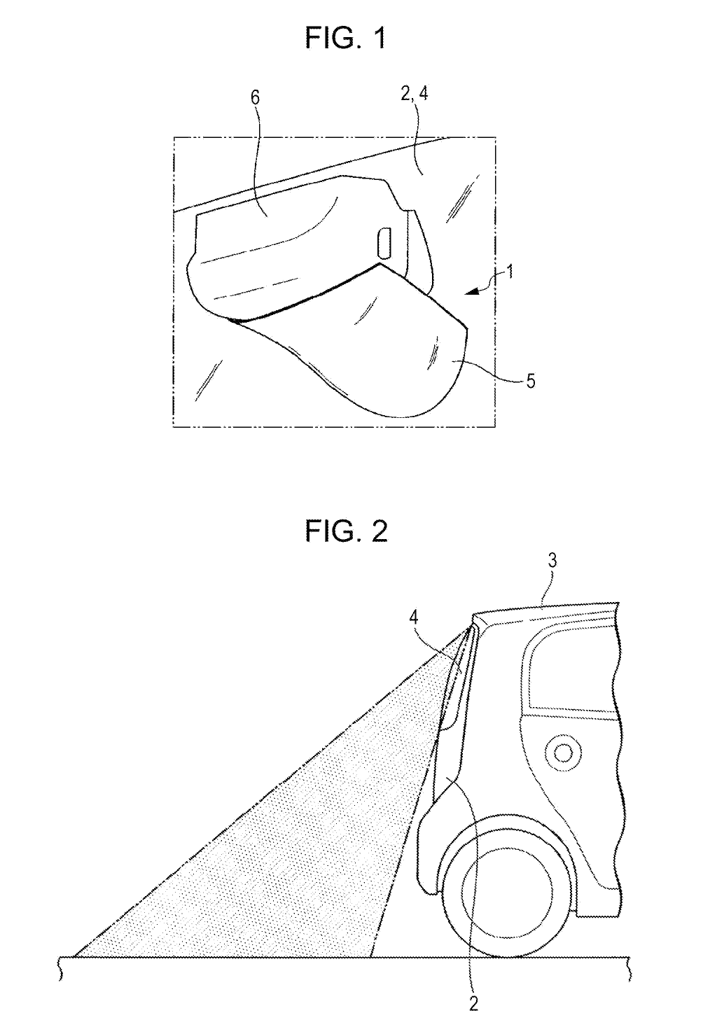

A mirror device according to an embodiment of the present invention will be described below with reference to the drawings, wherein like reference numerals designate corresponding or identical elements throughout the various drawings. Referring to FIGS. 1 and 2, the mirror device, indicated at 1, according to this embodiment is placed in substantially the middle of the top of a rear window 4 in the width direction of a vehicle 3, such as a van, including a tailgate 2. The mirror device 1 is configured to allow an area behind and below the rear window 4 which cannot be directly viewed by a driver to be visible as a mirror image using a reflecting surface 5. FIG. 1 illustrates the reflecting surface 5 attached to a vehicle interior member 6 disposed on upper part of the rear window 4 in the interior of the vehicle.

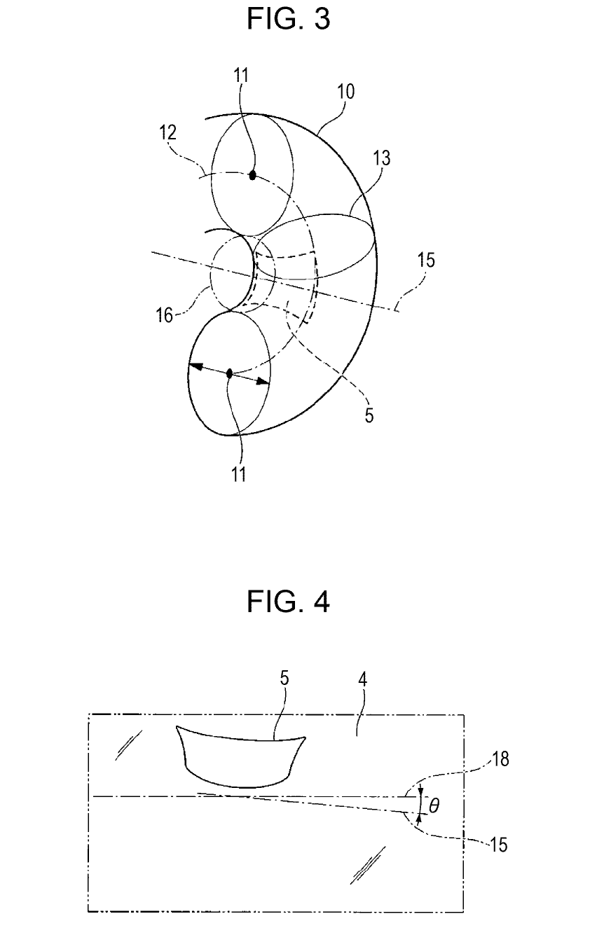

The reflecting surface 5 includes a curved surface that is concave in the longitudinal direction of the surface and is convex in the lateral direction thereof. The reflecting surface 5 is a toroidal mirror surface that serves as part of the radially inward-facing surface of a toroidal object 10 illustrated in FIG. 3. In the following description, the direction along the circumference of the toroidal object 10 will be called the “longitudinal direction” of the reflecting surface 5 and the direction along the thickness (indicated by arrows in FIG. 3) of the toroidal object 10 will be called the “lateral direction” thereof.

Convex part of the reflecting surface 5 in the lateral direction is defined by a circle 13 whose center coincides with the circumference of a circle 12 that coincides with the center 11 of the cross section of the toroidal object 10. On the other hand, concave part of the reflecting surface 5 in the longitudinal direction is defined by a circle 16 whose center coincides with an axis 15 extending in the horizontal direction. As will be seen from the fact that the shape in the lateral direction of the reflecting surface 5 is convex, the radius of the circle 16 increases as the circle 16 approaches each end in the lateral direction of the reflecting surface 5. A change in the radius in the lateral direction is based on the curvature of the above-described circle 13.

The reflecting surface 5, serving as such a toroidal mirror surface, is attached near the rear window 4 in the interior such that the longitudinal direction of the reflecting surface 5 is inclined relative to the length direction of the vehicle. The angle of inclination of the reflecting surface 5 is set to the optimum angle providing the highest visibility in accordance with conditions that vary depending on the type of vehicle, e.g., the size of the rear window 4 and the position of attachment of the reflecting surface 5.

FIG. 4 illustrates a state in which the reflecting surface 5 attached while being inclined in the length direction of the vehicle 3 which is right-hand drive is observed from the front part of the vehicle. As illustrated in FIG. 4, the axis 15 passing through the center of the circle 16 defining the concave part of the reflecting surface 5 is inclined relative to a horizontal line 18 extending in the vehicle width direction toward a side opposite to a driver seat in the vehicle width direction.

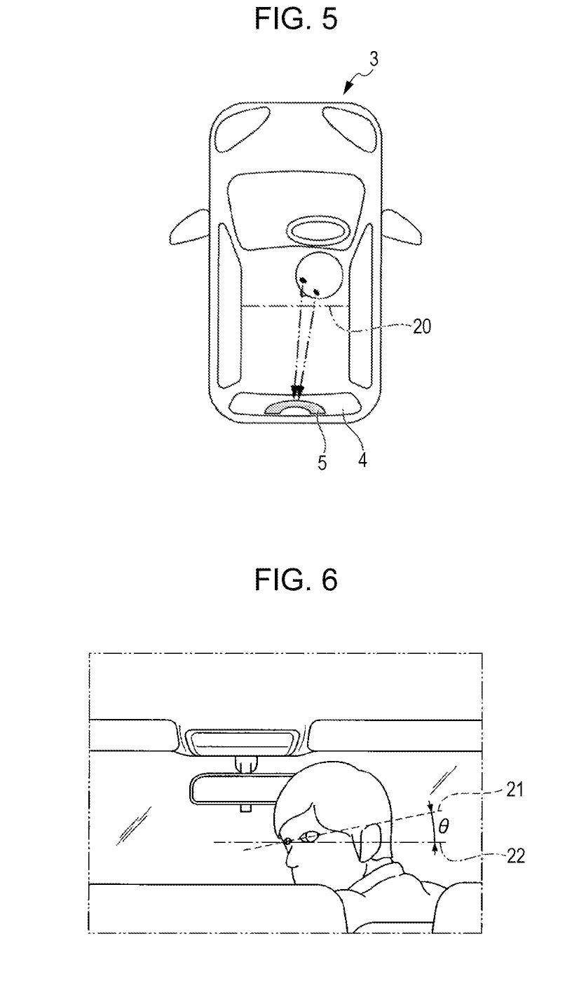

As illustrated in FIG. 5, to view the rear window 4 in the right-hand drive vehicle 3, the driver usually turns his or her head leftward, namely, turns around from the middle in the vehicle width direction. In this case, as illustrated in FIG. 6, the level of the right eye of the driver is statistically most often lower than that of the left eye. Accordingly, the reflecting surface 5 is attached to the right-hand drive vehicle 3 while the axis 15 is inclined to the left of the vehicle opposite to the driver seat in the vehicle width direction so that when the driver turns around, the driver views the reflecting surface 5 inclined to the right.

As illustrated in FIG. 6, an angle θ formed by the above-described axis 15 with the horizontal line 18 extending in the vehicle width direction is set to substantially the same as an angle formed by a line connecting the right and left eyes of the driver viewed from the rear part of the vehicle 3 when the driver turns around backward in order to view the rear window 4, namely, a line 21 connecting the right and left eyes of the driver projected on a virtual plane 20 (see FIG. 5) that extends in the height and width directions of the vehicle 3 with a horizontal line 22 extending in the vehicle width direction on the same plane.

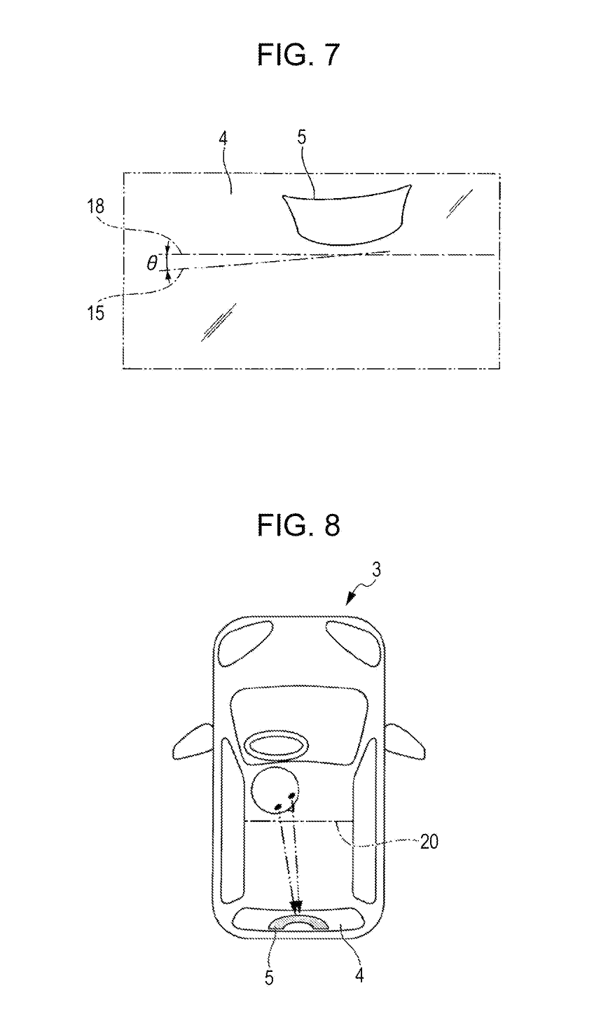

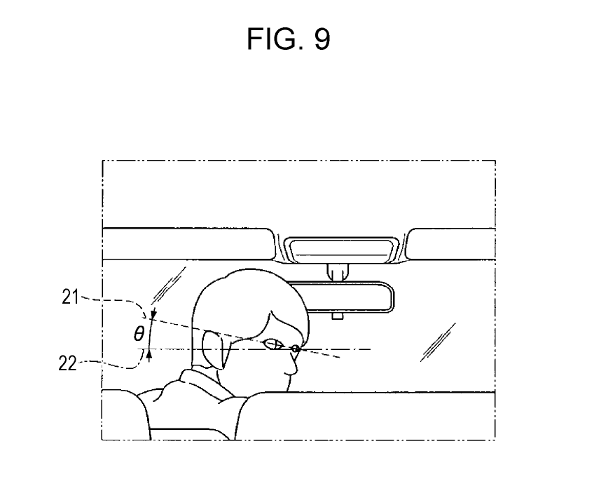

In the case where the vehicle 3 is left-hand drive, the reflecting surface 5 is attached such that the reflecting surface 5 is inclined in a direction opposite to that in the right-hand drive vehicle 3, namely, such that the reflecting surface 5 is inclined relative to the horizontal line 18 to the right of the vehicle opposite to the driver seat in the vehicle width direction, as illustrated in FIG. 7. The reason is that when the driver turns around toward the rear of the vehicle from the middle in the vehicle width direction, as illustrated in FIG. 8, the level of the left eye of the driver is statistically most often lower than that of the right eye. As illustrated in FIG. 9, the angle θ formed by the axis 15 passing through the center of the circle 16 defining the concave part of the reflecting surface 5 with the horizontal line 18 extending in the vehicle width direction is set to substantially the same as the angle θ formed by the virtual line 21 connecting the right and left eyes of the driver with the horizontal line 22 extending in the vehicle width direction.

The above-described angle θ is determined in accordance with the levels of the right and left eyes of the driver when the driver turns around toward the rear of the vehicle from the middle in the vehicle width direction. Since the angle θ varies from individual to individual depending on the driver's habit, the angle θ is not uniquely determined. Therefore, the levels of the right and left eyes of drivers are actually measured and the averages of the levels are used to set the angle θ. The mirror device 1 may further include a mechanism for allowing the reflecting surface 5 to be inclined in the vehicle width direction. When the reflecting surface 5 is inclinable in the vehicle width direction, the driver can appropriately finely adjust the above-described angle θ according to, for example, his or her habit so that the driver can easily view the reflecting surface 5.

According to the mirror device 1 of the above-described embodiment, the reflecting surface 5, serving as the toroidal mirror surface, including the concave part in the longitudinal direction of the surface and the convex part in the lateral direction thereof is attached such that the axis 15 of the circle 16 defining the concave part is inclined toward a side opposite to the driver seat in the vehicle width direction. For example, assuming that the driver, sit on the driver seat, views the reflecting surface 5 near the rear window 4, if the level of the right or left eye on the side opposite to the driver seat in the vehicle width direction is lower than that of the other eye, the parallax of the right and left eyes caused when an object on the concave part of the reflecting surface 5 is observed can be solved because the concave part is inclined in the direction in which the line connecting the levels of the right and left eyes is inclined. Consequently, the mirror device 1 can allow the driver to immediately recognize an object as a mirror image without making the driver feel uncomfortable or feel that the mirror image is difficult to see.

As for the angle by which the axis 15 of the circle 16 defining the concave part is inclined, the angle formed by the line 21 connecting the right and left eyes of the driver sit on the driver seat in the vehicle width direction when the driver turns around toward the rear of the vehicle with the horizontal line 22 is used. For example, when the angle is actually measured or the average of actually measured angles is set, the mirror device 1 more effectively allows the driver viewing the reflecting surface 5 to immediately recognize an object as a mirror image without making the driver feel uncomfortable or feel that the mirror image is difficult to see.

When the reflecting surface 5 is mounted inclinably in the vehicle width direction, the angle of the reflecting surface 5 can be adjusted according to individual difference in the levels of the right and left eyes of a driver. Consequently, the mirror device 1 can support various users, thus further increasing the saleability.

The present invention is not limited to the configuration of the mirror device 1 according to the above-described embodiment and many changes and modifications thereof may be constructed without departing from the scope of the invention. For example, the above-described embodiment has been described with respect to the case where the reflecting surface 5 is cut from the radially inward-facing surface of the toroidal object 10 such that the reflecting surface 5 extends along the axis 15 and the shape of the reflecting surface 5 is substantially a rectangle when viewed from the front. The shape of the reflecting surface 5 is not limited to the rectangle. The curvatures of the circles 13 and 16 defining the concave and convex parts of the reflecting surface 5 and the length, width, and height of the reflecting surface 5 may be appropriately set according to the size of the rear window 4 and that of the tailgate 2 of the vehicle 3 to which the mirror device 1 is attached so that a necessary area can be observed as a mirror image.

According to the embodiment of the present invention, the reflecting surface serves as a toroidal mirror surface including concave part in the longitudinal direction of the surface and convex part in the lateral direction thereof. For example, assuming that a driver, sit on the driver seat on the right or left of the vehicle in the vehicle width direction, views the reflecting surface near the rear window, if the level of the eye on a side opposite to the driver seat in the vehicle width direction is lower than that of the other eye, the parallax of the right and left eyes caused when an object on the concave part of the reflecting surface is observed can be solved because the direction in which the line connecting the right and left eyes coincides with the direction in which the reflecting surface is inclined. Advantageously, the mirror device can allow the driver to immediately recognize an object as a mirror image without making the driver feel uncomfortable or feel that the mirror image is difficult to see.

Preferably, the angle by which the line passing through the center of the virtual circle is inclined is set to an angle formed by a virtual line (e.g., a line 21 in the embodiment) connecting the levels of the right and left eyes of a driver sit on the driver seat when the driver turns around toward the rear of the vehicle with a virtual horizontal line (e.g., a horizontal line 22 in the embodiment) extending in the vehicle width direction.

Advantageously, the mirror device can more effectively allow the driver to immediately recognize an object as a mirror image without making the driver feel uncomfortable or feel that the mirror image is difficult to see.

The reflecting surface may be mounted inclinably in the vehicle width direction.

In this case, the angle of the reflecting surface can be adjusted according to individual difference in the levels of the right and left eyes of a driver. Advantageously, the saleability of the device can be further increased.

Obviously, numerous modifications and variations of the present invention are possible in light of the above teachings. It is therefore to be understood that within the scope of the appended claims, the invention may be practiced otherwise than as specifically described herein.

What is claimed is:

1. A mirror device comprising:
a reflecting surface arranged in a vicinity of a rear window of a vehicle and including a concave part in a longitudinal direction of the reflecting surface and a convex part in a lateral direction of the reflecting surface, a line passing through a center of a virtual circle defining the concave part being inclined relative to a virtual horizontal line extending in a vehicle width direction toward a side opposite to a driver seat on either right or left of the vehicle in the vehicle width direction.

2. The mirror device according to claim 1, wherein an angle by which the line passing through the center of the virtual circle is inclined is set to an angle formed by a virtual line connecting levels of right and left eyes of a driver sit on the driver seat when the driver turns around toward a rear of the vehicle with a virtual horizontal line extending in the vehicle width direction.

3. The mirror device according to claim 1, wherein the reflecting surface is mounted inclinably in the vehicle width direction.

4. The mirror device according to claim 2, wherein the reflecting surface is mounted inclinably in the vehicle width direction.
